(19) United States
(12) Patent Application Publication
(10) Pub. No.: US 2009/0053465 A1
(43) Pub. Date: Feb. 26, 2009

(54) SCRATCH RESISTANT, REFLECTION REDUCING SURFACE HAVING ANTI-FOGGING PROPERTIES

(75) Inventors: Gerd-Peter SCHERG, Balcham (DE); Cecille Stolz, Muenchen (DE); Baerbel Goetz, Augsburg (DE); Kevin Fuechsel, Jena (DE); Norbert Kaiser, Jena (DE); Ulrike Schulz, Jena (DE)

Correspondence Address: CROWELL & MORING LLP;INTELLECTUAL PROPERTY GROUP, P.O. BOX 14300, WASHINGTON, DC, 20044-4300, US

(73) Assignees: Rodenstock GmbH, Muenchen (DE); Fraunhofer-Gesellschaft zur Foerderung der angewandten Forschung e. V., Muenchen (DE)

(21) Appl. No.: 12/196,905

(22) Filed: Aug. 22, 2008

Related U.S. Application Data
(63) Continuation of application No. PCT/EP2007/001013, filed on Feb. 6, 2007.

(30) Foreign Application Priority Data
Feb. 24, 2006 (DE) 10 2006 008 784.4

(51) Int. Cl. B32B 3/10; B05D 5/06; B05D 3/14; B05D 3/06

(52) U.S. Cl. 428/137; 427/165; 427/552; 427/555; 427/560

(57) ABSTRACT

An optical element or component having excellent anti-fog effects as well as excellent scratch resistance and/or reflection reducing effects and optionally also hydrophobic and/or oleophobic properties, and a method for producing such an optical element or component. The element or component includes, in the following order, a glass substrate, a water-absorbing first layer, and a second layer selected from (i) an anti-reflecting coating; a mirror coating and a hard layer; (ii) a compound and/or combination of a hard layers and anti-reflecting coatings; and (iii) a compound and/or combination of hard layers and mirror coating. Blind holes or bores are introduced into the second layer and the water-absorbing first layer with the holes opening out from the second layer and extending completely through the second layer, and at least partially through the water-absorbing first layer.

### CROSS REFERENCE TO RELATED APPLICATIONS

This application is a continuation of international patent application no. PCT/EP2007/001013, filed Feb. 6, 2007, designating the United States of America and published in German on Sep. 7, 2007 as WO 2007/098843, the entire disclosure of which is incorporated herein by reference. Priority is claimed based on Federal Republic of Germany patent application no. DE 10 2006 008 784.4, filed Feb. 24, 2006.

### BACKGROUND OF THE INVENTION

The present invention relates to an optical element or component, which has an excellent anti-fogging effect and/or anti-misting effect, and which, in addition, exhibits an excellent scratch resistance and/or reflection reducing effect and optionally even exhibits hydrophobic and/or oleophobic properties, and to a method for its manufacture.

There exist in the state of the art methods for realizing non-fogging surfaces by applying a water absorbing or rather hydrophilic layer (cf. JP 2001097744 A2, JP 2003206435 A2, EP 0 782 015 B1 or JP 2001074902 A2) or a hydrophobic top coat layer (cf. EP 0 927 144 B1). Furthermore, there exist methods to prevent surfaces from fogging by means of a photocatalytic layer (U.S. Pat. No. 6,013,372), by heating (U.S. Pat. No. 5,471,036), by modifying a polymer substrate with the addition of an additive (WO 01/58987 A2) or by means of an oxide system without any organic component (US 2002/0192365 A1). In addition, efforts have been made to achieve simultaneously an anti-reflection and anti-misting or rather anti-fogging effect (cf. US 2004/0201895 A1, US 2003/0030909 A1, EP 1 324 078 or EP 0871 046 A1). The common feature of most of the state of the art methods for producing an anti-fogging effect is either the application of a flat layer, which is made of a material to reduce fogging, to a surface or the addition of additives that exhibit a fogging-reducing effect. However, the negligible scratch resistance of the typical water absorbing film limits the use of such surfaces.

### SUMMARY OF THE INVENTON

It is therefore an object of the present invention to provide optical elements and/or components, in particular spectacle lenses, which exhibit an anti-fogging effect, and which are to exhibit an excellent scratch resistance and/or anti-reflection effect.

Another object of the invention is to provide optical elements with anti-fogging properties which are particularly suitable for spectacle lenses.

A further object of the invention is to provide optical elements with anti-fogging properties which also exhibit hydrophobic and/or oleophobic properties.

These and other objects are achieved in accordance with the present invention by providing optical elements as described and claimed hereinafter.

In particular, the present invention provides an optical element and/or component, comprising in the following order a glass substrate, a water absorbing first layer and a second layer or rather an outer layer, selected from (i) an anti-reflection coating, a mirror coating or a hard layer or (ii) a composite and/or a combination of hard layer and anti-reflection coating or (iii) a composite and/or a combination of hard layer and mirror coating. In this case blind holes are introduced into the second layer and the water absorbing first layer. Said blind holes, emerging or open out from the second layer, completely penetrate the second layer and at least partially penetrate the water absorbing first layer.

One embodiment of the present invention selects the second layer, composed of an anti-reflection coating or a mirror coating.

Furthermore, a variety of layer materials can be sandwiched between the first and the second layer, in order to create a transition and/or an enhanced compatibility, for example, between the water absorbing inner layer and the hard outer layer. That is to say, so-called compensating layers can be provided. Suitable materials for such a layer are, for example, synthetic plastic materials and/or oxides.

According to an especially preferred embodiment of the present invention, the optical element and/or component is a spectacle lens.

The sack-like depressions or rather boreholes or rather blind holes or rather channels, which are introduced into the second layer, selected from (i) an anti-reflection coating, a mirror coating or a hard layer (that is, a cover layer hardening the surface) or (ii) a composite and/or a combination of hard layer and anti-reflection coating or (iii) a composite and/or a combination of hard layer and mirror coating, and the water absorbing layer, and which, open out from the second layer, extend completely through this second layer and at least partially through the water absorbing first layer, are in principle not subject to any special constraint with respect to their shape and dimensions. These blind holes which open from the second layer, or an additional layer optionally applied over the second layer, are introduced or rather drilled by mechanical means, by a heating effect or by a radiation or laser effect and completely penetrate the second layer and at least partially penetrate the water absorbing layer. However, it is preferred that the blind holes do not completely penetrate the water absorbing layer—in the direction of its width—but rather terminate inside the water absorbing layer. Preferably the blind holes do not completely penetrate the water absorbing layer—in the direction of its width—but rather terminate, with respect to the width of the water absorbing layer, in the water absorbing layer at a depth ranging from 5 to 80%, particularly preferably from 5 to 40%.

As the second layer, the anti-reflection coating may exhibit a single layer or multi-layer construction. Such anti-reflection coatings, which are constructed as a single layer or multiple layers, are known to persons skilled in the art; and a person skilled in the art is able to select in an appropriate way suitable materials and layer thicknesses of an anti-reflection coating and/or individual anti-reflection layers. Preferably an anti-reflection coating that is constructed of one, two, three, four, five or six layers is selected. In the case of anti-reflection coatings that are constructed of two or more layers, it is customary to select a type of layer sequence, in which an anti-reflection layer having a high index of refraction is adjacent to an anti-reflection layer having a low index of refraction. In other words, for this type of multi-layered construction it is preferred that the anti-reflection layers having a low index of refraction and anti-reflection layers having a high index of refraction alternate with one another. In addition, additional layers, for example adhesion layers (for example, having a thickness in a range of approximately 5 nm to 5 μm), which do not have to exhibit any optical function, but may be beneficial for the durability, adhesion properties, stability to the environment, etc., can be provided. For example, it is also possible to replace the aforementioned anti-reflection coating with a mirror coating, comprising one or more mirror layer(s) and optionally anti-reflection layers, or to provide both an anti-reflection coating and a mirror coating.

Examples of suitable materials for the anti-reflection and/or mirror coating include metals, non-metals, like silicon or boron, oxides, fluorides, silicides, borides, carbides, nitrides, and sulfides of metals and the aforementioned non-metals. These substances may be used individually or as a mixture of two or more of these materials. Preferred metal oxides and/or non-metal oxides include SiO, SiO₂, ZrO₂, Al₂O₃, TiO, TiO₂, Ti₂O₃, Ti₃O₄, CrO, (where x=1-3), like Cr₂O₃, Y₂O₃, Yb₂O₃, MgO, Ta₂O₅, CeO₂ and HfO₂. Preferred fluorides include MgF₂, AlF₃, BaF₂, CaF₂, Na₃AlF₆ and Na₅Al₃F₁₄. Preferred metals include, for example, Cr, W, Ta, and Ag.

It is especially preferred to use SiO₂ as the material for the last or rather outermost (when viewed starting from the surface of the optical element and/or component) anti-reflection layer—that is, the anti-reflection layer, which can make contact, as explained below, with an optionally provided hydrophobic and/or oleophobic coating.

The above described anti-reflection and/or mirror coating may be applied by conventional methods. In this case it is preferred to apply the individual anti-reflection layers by means of evaporation, sputtering, chemical vapor deposition [CVD] or plasma enhanced CVD methods.

It is especially preferred to deposit and/or apply the anti-reflection coating, for example, by plasma ion assisted deposition in such a manner that a compacted layer is formed that exhibits a high abrasion resistance and preferably exhibits a porosity of less than 20%.

The layer thickness of the anti-reflection coating that is made of one layer or a plurality of layers, is not subject in principle to any constraint. However, it is set preferably to a thickness of ≦2,000 nm, preferably ≦1,500 nm, especially preferred ≦300 nm. However, the minimum layer thickness of the anti-reflection coating is preferably approximately ≧100 nm. In the case of a multi-layered construction of the anti-reflection or mirror coating, the thickness of each individual layer (that is, the anti-reflection layer) is set, as stated above, in a suitable way.

For example, such an anti-reflection coating can be made of alternatingly high and/or low refractive layers of TiO₂ and/or SiO₂, with for example λ/8 TiO₂, λ/8 SiO₂, λ/2 TiO₂, and λ/4 SiO₂, if λ stands for light having a wavelength of 550 nm. This type of anti-reflection coating exhibiting a multi-layer construction can be produced, for example, by well-known physical vapor deposition [PVD] methods.

The water absorbing layer is a layer that is suitable to absorb moisture from the air by means of the blind holes or rather channels that are provided in the anti-reflection or mirror coating or in the cover layer hardening the surface, in order to prevent the glass surface from fogging. Therefore, the water absorbing layer is made chiefly of a hydrophilic material, which may be of an inorganic or organic nature.

The water absorbing layer is preferably a water absorbing polymer layer and can be, for example, a so-called anti-fogging film. Suitable materials for the water absorbing polymer layer include, of course, polymers, like starch polymers, like hydrolysates of starch acrylonitrile graft polymers, and cellulose polymers, like cellulose acrylonitrile graft polymers, and synthetic polymers, like polyvinyl alcohol polymers, like cross-linked polyvinyl alcohol, acrylic polymers, like cross-linked sodium polyacrylate, and polyether polymers, like cross-linked polyethylene glycol diacrylate, where polyacrylates and polyvinyl alcohol are preferred. Examples of polyacrylates include polyacrylic acid, polymethacrylic acid, polyacrylamide and salts, like potassium polyacrylate, sodium polyacrylate, etc. Suitable materials for the water absorbing layer include, for example, the polymers that are described in U.S. Pat. No. 6,287,683 (=EP 871,046), the entire disclosure of which is incorporated herein by reference.

The layer thickness of the water absorbing layer is not subject in principle to any special constraint. However, it is set preferably to a thickness ranging from 0.5 to 12 μm, especially preferred 5 to 10 μm.

The blind holes or rather channels that are introduced into the second layer and the water absorbing layer are not subject to any significant constraint. However, they exhibit preferably a diameter in a range of 0.1 μm to 10 μm, especially preferred in a range of 0.1 to 5 μm. In this case the blind holes may be designed, for example, so as to be in essence round or elliptical. The depth or rather the length of the introduced blind holes varies as a function of the selected thickness of the second layer and the water absorbing layer. Usually the blind holes are not visible to the naked eye when looking at the surface of the optical element or component.

The distance from blind hole center to blind hole center (pitch)—that is, between two adjacent and/or adjoining blind holes—ranges, based on the surface of the second layer, preferably from 20 μm to 1 mm, especially preferred from 30 μm to 0.5 mm. The blind holes preferably occupy less than 30%, especially preferably less than 10%, of the surface of the second layer. In other words, the thickness and/or covering of the blind holes or rather channels is usually in a range of 100 to 250,000 per cm², especially preferably in a range of 400 to 100,000 per cm².

The method by which these blind holes are introduced into the second layer and at least partially into the water absorbing layer is not subject to any special constraint. However, it is preferred to introduce and/or provide the blind holes so as to extend substantially perpendicular to the surface of the optical element or component.

The term “glass substrate” is used herein in an expansive sense and is intended to embrace any material suitable for use as a lens material whether or not such material is composed of fused mineral substances. Thus, the glass substrate for the optical element and/or component of the invention, which is preferably a spectacle lens, may be made of a synthetic resin (i.e., plastic) material or an inorganic material. A treated or untreated synthetic resin lens material, for example made of polythiourethane, PMMA, polycarbonate, polyacrylate or polydiethylene glycol bisallylcarbonate (CR 39®) or a treated or untreated mineral glass can be used as the glass substrate.

In one embodiment of the invention a hard layer, into which the aforementioned blind holes do not penetrate, can be provided between the glass substrate and the water absorbing layer. That is, the hard layer remains untouched by the blind holes. In another embodiment of the present invention, a hard layer may be provided between the water absorbing layer and the anti-reflection or mirror coating. Correspondingly preferred configurations of the layer construction of the inventive optical element or component include:

glass substrate/hard layer/water absorbing layer/anti-reflection coating and/or
glass substrate/water absorbing layer/hard layer/anti-reflection coating and/or
glass substrate/hard layer/water absorbing layer/hard layer/anti-reflection coating.

The hard layer, which may also be provided, as stated above, as the second layer, disposed directly on the water absorbing first layer, is not subject to any special constraint. The hard layer may exhibit a single layer or multi-layer construction. In order to manufacture the hard layer, a variety of materials and methods may be used. A person skilled in the art is able to select in a suitable way appropriate materials for the hard layer and the thickness of the hard layer. Usually the hard layer is applied in the form of a hard film or an inorganic material, in particular based on quartz, by means of plasma enhanced layer deposition techniques or CVD methods. The hard film is usually applied by means of conventional methods, like a dip method, a spray method or a spin coating method. However, it is preferred to use a hard layer, based on an acrylic polymer, a urethane polymer, a melamine polymer, a silicone resin or an inorganic material, in particular, based on quartz. According to an especially preferred embodiment, a silicone resin is applied as the hard layer on the surface of the optical element and/or component, for example, starting from siloxanes. In this case the hard layer may be disposed completely or in certain areas above the water absorbing polymer layer.

Suitable silicone resins exhibit a composition, which comprises one or more of the following components:
(1) organosiloxane compounds with or without functional groups, like glycidoxypropyltrimethoxysilane,
(2) co-reactants for functional groups of functional organosilanes, like organic epoxides, amines, organic acids, organic anhydrides, imines, amides, ketamines, acrylic compounds and isocyanates,
(3) colloidal silicon dioxides, brines and/or metal and non-metal oxide brines, which exhibit preferably an average particle diameter ranging from approximately 1 to approximately 100 nm and especially preferred from approximately 5 nm to approximately 40 nm,
(4) catalysts for the silanol condensation, like dibutyl tin dilaurate, zinc naphthenate, aluminum acetylacetonate, zirconium octoate, lead-2-ethylhexoate, aluminum alcoxides and aluminum alcoxide organosilicone derivatives and titanium acetylacetonate,
(5) catalysts for co-reactants, like epoxy catalysts and catalysts of the free radical type,
(6) solvents, like water, alcohols, and ketones,
(7) surfactants, like fluorinated surfactants or surfactants of the polydimethylsiloxane type,
(8) other additives, such as fillers. Materials of this type are described, for example, in U.S. Pat. No. 5,619,288 (=EP 871,907), the entire disclosure of which is incorporated herein by reference. See in particular the paragraphs [0023] to [0026].

The layer thickness of the hard layer is not subject in principle to any special constraint. However, it is set preferably to a thickness of ≦20 μm, more preferred 1 to 15 μm, especially preferred 1 to 5 μm.

Furthermore, a hydrophobic and/or oleophobic coating can be applied to the second layer, selected from (i) an anti-reflection coating, a mirror coating or a hard layer or (ii) a composite and/or a combination of hard layer and anti-reflection coating or (iii) a composite and/or a combination of hard layer and mirror coating. In this case then even this hydrophobic and/or oleophobic coating is perforated, according to the invention, by the above-defined blind holes. Suitable hydrophobic and/or oleophobic coatings are known to the person skilled in the art and are not subject in principle to any special constraint, as long as the result is a coating that has hydrophobic and/or oleophobic properties and exhibits adequately good adhesion properties, such as silane-based materials.

The hydrophobic and/or oleophobic coating comprises preferably a silane having at least one fluorine-containing group, which exhibits preferably more than 20 carbon atoms. However, the layer can also be made of a corresponding siloxane or silizane, which comprises preferably at least one fluorine-containing group. The silane having at least one fluorine-containing group is based preferably on one silane having at least one hydrolyzable group. Suitable hydrolyzable groups are not subject to any special constraint and are known to the person skilled in the art. Examples of hydrolyzable groups, which are bonded to a silicon atom, include halogen atoms, such as chlorine, —N-alkyl groups, such as —N(CH₃)₂ or —N(C₂H₅)₂, alkoxy groups or isocyanate groups, where an alkoxy group, in particular a methoxy group or ethoxy group, is preferred as the hydrolyzable group. However, it is also possible to use a silane having at least one fluorine-containing group, which carries at least one hydroxyl group. The silane having at least one fluorine-containing group comprises preferably one or more polyfluorinated group(s) or one or more perfluorinated group(s), where one or more polyfluorinated or perfluorinated alkyl group(s), one or more polyfluorinated or perfluorinated alkenyl group(s) and/or one or more polyfluorinated or perfluorinated polyether units-containing group(s) are especially preferred. Preferred polyether units-containing groups comprise one or more —(CF₂)ₓO unit(s), where x=1 to 10, and x=2 to 3 is especially preferred.

According to one preferred embodiment of the invention, the silane exhibits a fluorine-containing group and three hydrolyzable groups or hydroxyl groups. Furthermore, it can be preferred that a hydrophobic and/or oleophobic coating is made of a polyfluorinated or perfluorinated hydrocarbon compound. The polyfluorinated or perfluorinated hydrocarbon compound is not subject to any significant constraint. However, it is preferred to use polytetrafluoroethylene as the polyfluorinated or perfluorinated hydrocarbon compound. The hydrophobic and/or oleophobic coating is made preferably exclusively of a silane having at least one fluorine-containing group or a polyfluorinated or perfluorinated hydrocarbon compound. However, it is also possible to use a mixture of one or more of these silanes and/or one or more polyfluorinated or perfluorinated hydrocarbon compound(s), with or without additional inorganic, metal-organic or organic auxiliary substances for the hydrophobic and/or oleophobic coating. The hydrophobic and/or oleophobic coating can be applied by conventional methods. In this case it is preferred to apply this coating by layer evaporation, chemical vapor deposition [CVD] methods or by a dip method.

The layer thickness of the hydrophobic and/or oleophobic coating is not subject in principle to any special constraint. However, it is set preferably to a thickness of ≦50 nm, preferably ≦20 nm.

The hardness of the materials, used in the inventive optical element and/or component to make the individual layers, is usually selected in such a manner that it increases preferably in the following order of sequence: material for the water absorbing layer<silicone film<cover layers produced in the vacuum process.

### BRIEF DESCRIPTION OF THE DRAWINGS

FIG. 1 depicts an embodiment of the inventive spectacle lens, comprising a glass substrate (1), a hard layer (2) (as the optional layer), a water absorbing layer (3) and an anti-reflection coating (4). The anti-reflection coating (4) and the water absorbing layer (3) exhibit blind holes (5), which, emerging from the anti-reflection coating (4), are introduced in the direction of the arrow, shown in FIG. 1, and completely penetrate the anti-reflection coating (4) and at least partially penetrate the water absorbing layer (3) and end in the water absorbing layer (3).

FIG. 2 depicts another embodiment of the inventive spectacle lens, comprising a glass substrate (1), a hard layer (2) (as the optional layer), a water absorbing layer (3), an additional hard layer (2a) and an anti-reflection coating (4). The anti-reflection coating (4), the additional hard layer (2a) and the water absorbing layer (3) exhibit blind holes (5), which, emerging from the anti-reflection coating (4), are introduced in the direction of the arrow, shown in FIG. 2, and completely penetrate the anti-reflection coating (4) and the hard layer (2a) and at least partially penetrate the water absorbing layer (3) and end in the water absorbing layer (3).

FIG. 3 depicts another embodiment of the inventive spectacle lens, comprising a glass substrate (1), a water absorbing layer (3) compensating layers (2b), and a hardening cover layer (4), which is made of an AR coating and one or more hard oxide layer(s). The hardening cover layer (4), the compensating layers (2b) and the water absorbing layer (3) exhibit blind holes or rather channels (5), which, emerging from the hardening cover layer (4), are introduced in the direction of the arrow, shown in FIG. 3, and completely penetrate the hardening cover layer (4) and the compensating layers (2b) and at least partially penetrate the water absorbing layer (3) and end in the water absorbing layer (3).

FIG. 4 depicts a light optical microscope image of the sample surface of an inventive spectacle lens with dot-shaped blind holes, which are provided so as to be spaced apart from each other in a lattice pattern and exhibit a spacing of approximately 20 to 50 μm.

Furthermore, the present invention provides a method which is intended for producing an optical element and/or component, preferably a spectacle lens, and comprises, in the following order, the steps:
(a) providing a glass substrate,
(b) applying a water absorbing layer,
(c) applying a second layer, selected from (i) an anti-reflection coating, a mirror coating or a hard layer or (ii) a composite and/or a combination of hard layer and anti-reflection coating or (iii) a composite and/or a combination of hard layer and mirror coating,
(d) introducing in certain places blind holes or rather channels opening from the surface of the second layer and extending into the second layer and into the water absorbing layer such that the second layer is completely penetrated and the blind holes penetrate at least partially the water absorbing layer.

The method, with which the blind holes are introduced into the second layer and the water absorbing layer, is not subject to any special constraint. However, it is preferred to introduce the blind holes, emerging from the second layer, into the second layer and at least partially into the water absorbing layer by means of laser bombardment, sand blasting treatment, electron beam lithography, ion beam process, ultrasonic bombardment or a water jet. For example, the second layer can be perforated and/or punched, based on its surface, area-by-area and/or point-by-point by means of one of the aforementioned methods and can be completely penetrated in the direction of its thickness, in order to expose area-by-area or point-by-point the water absorbing layer. The blind holes or rather channels are introduced at least in certain places into the water absorbing layer, in order to guarantee the water absorbing effect. However, it is not necessary to drill through the entire water absorbing layer.

Preferably the blind holes are introduced and/or provided in essence so as to be perpendicular to the surface of the optical element and/or component. However, it is also possible, starting from the outermost layer, for example the anti-reflection coating or mirror coating or optionally the hydrophobic and/or oleophobic coating, which is disposed on said outermost layer, to introduce such blind holes at an angle deviating from an orthogonal line to the glass surface.

The following examples are presented in order to illustrate the invention in further detail the invention without the invention being limited to these examples.

### EXAMPLES

### Example 1

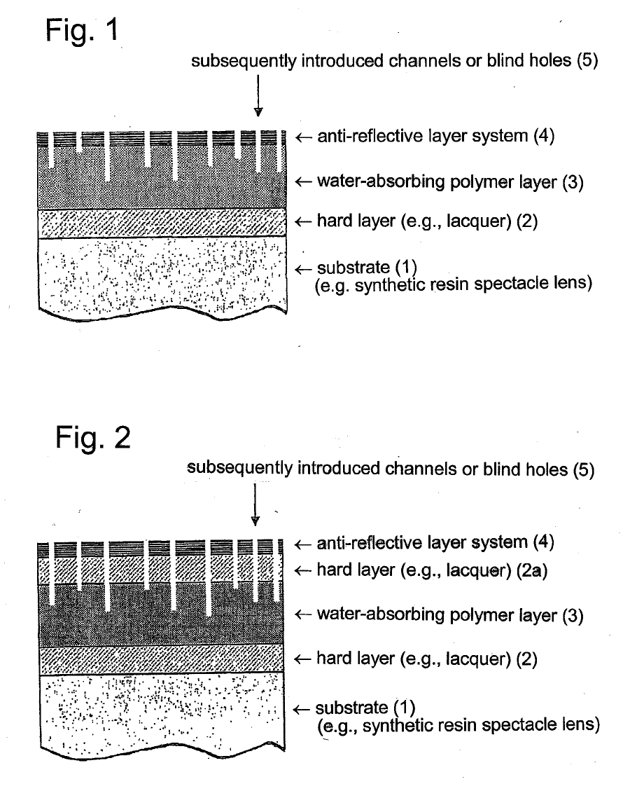

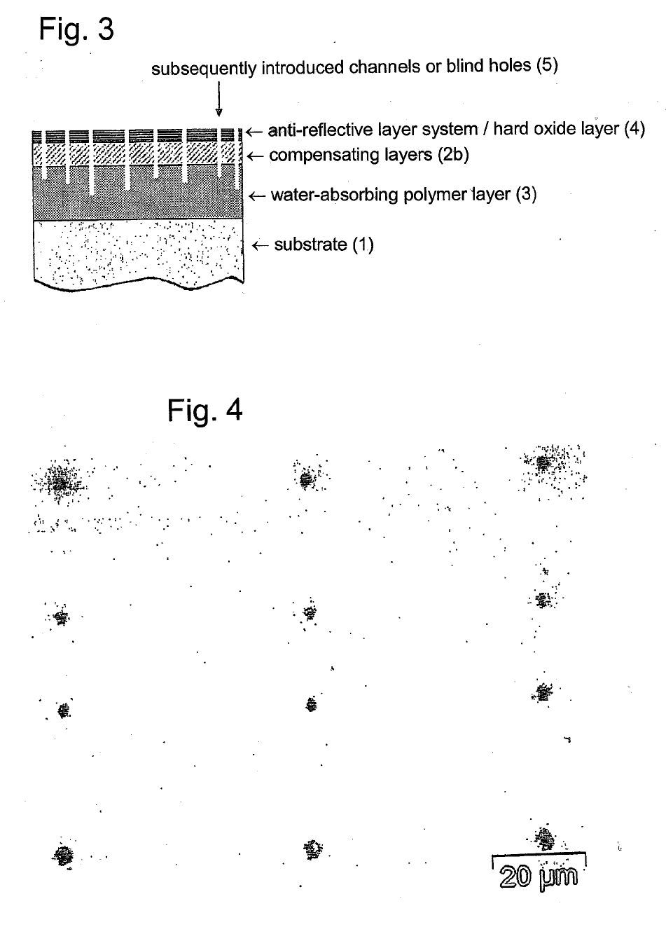

A synthetic resin lens is coated by the dip method with a hardening silicone film and then with a 5 μm thick water absorbing polymer layer having anti-fogging properties for example, AF-100™, Sci Cron Technologies or Crystal Coat AF 1140, SDC Technology Inc.). Using plasma ion enhanced layer deposition, an anti-reflection coating is deposited on this surface. This anti-reflection coating consists, for example, of 4 layers SiO₂/TiO₂ and exhibits a total thickness of 250 μm. Owing to the manufacturing conditions with densification of the layer by compression through the use of ions, the layer exhibits a high abrasion resistance and a natural porosity of less than 20%. Blind holes having a diameter of <2 μm at a distance ranging from 20 μm to 200 μm are introduced into this surface by means of a femtosecond laser (wavelength: 800 nm, pulse duration: 120 fs) (cf. FIGS. 1 and 2). In this case the holes, which are not visible to the eye, end at a depth of several micrometers inside the water absorbing layer (anti-fogging layer) (cf. FIG. 1). The original surface of the surface, which is produced in this way, exhibits hardly any adverse effects, since the holes occupy less than 5% of the surface. In the anti-fogging test the sample remains unfogged, since the condensing water is passed inwardly through the generated blind holes and is absorbed by the water absorbing anti-fogging layer. The anti-fogging test is conducted in accordance with DIN EN 168:2001, section 16 “Test of the Resistance of Transparent Panes to Fogging”.

### Example 2

A synthetic resin lens is coated with a hardening silicone film (thickness: 3 to 12 μm) and then coated with a hard anti-reflection layer system (thickness: 180 to 1,500 nm) in a vacuum process. Using a femtosecond laser, blind holes having a diameter of less than 1 μm are produced at a distance of at least approximately 20 μm so as to run perpendicular to the glass surface, starting from the side of the anti-reflection coating, so that said holes are not visible to the eye. Then if the dew point is exceeded at the surface, the condensing water is drawn into the blind holes due to the capillary effect. The sample remains unfogged as long as the blind holes are not completely filled with water.

### Example 3

A synthetic resin lens is coated with a hardening silicone film and then coated with an anti-fogging film (as in example 1) as the water absorbing layer and is coated thereafter again with the hardening silicone film. An anti-reflection layer system is applied to this surface in a vacuum process. The silicone film layer between the water absorbing polymer and the anti-reflection layer causes the mechanical properties to pass from the very soft anti-fogging material to the very hard anti-reflection layer and also serves to promote adhesion. The blind holes or rather channels are introduced in such a manner that they end inside the water absorbing polymer.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. An optical element or component, comprising in the following order:
a glass substrate,
a water absorbing first layer, and
a second layer, selected from the group consisting of:
(i) an anti-reflection coating, mirror coating or hard layer;
(ii) a composite or combination of a hard layer and an anti-reflection coating; and
(iii) a composite or combination of a hard layer and a mirror coating; wherein blind holes are formed in the second layer and the water absorbing first layer, said blind holes commencing from the surface of the second layer and extending completely through the second layer and at least partially through the water absorbing first layer.

2. An optical element or component as claimed in claim 1, wherein said blind holes have a diameter in the range from 0.1 μm to 10 μm.

3. An optical element or component as claimed in claim 1, wherein said blind holes at the surface of the second layer are spaced apart a distance of 20 μm to 1 mm.

4. An optical element or component as claimed in claim 1, wherein said blind holes occupy less than 30% of the surface of the second layer.

5. An optical element or component as claimed in claim 1, wherein said blind holes extend substantially perpendicular to the surface of the second layer.

6. An optical element or component as claimed in claim 1, further comprising a hard layer between the glass substrate and the water absorbing first layer or between the water absorbing first layer and an anti-reflection or mirror coating second layer, or both between the glass substrate and the water absorbing first layer and between the water absorbing first layer and an anti-reflection or mirror coating second layer.

7. An optical element or component as claimed in claim 6, having one of the following layer constructions:
glass substrate/hard layer/water absorbing layer/anti-reflection coating, or
glass substrate/water absorbing layer/hard layer/anti-reflection coating, or
glass substrate/hard layer/water absorbing layer/hard layer/anti-reflection coating.

8. An optical element or component as claimed in claim 1, further comprising a hydrophobic or oleophobic coating disposed over said second layer.

9. An optical element or component as claimed in claim 1, the water absorbing layer is a water absorbing polymer layer.

10. An optical element or component as claimed in claim 1, wherein the glass substrate is made of a transparent synthetic resin material or a transparent inorganic material.

11. A method for producing an optical element or component, said method comprising:
(a) providing a glass substrate;
(b) applying a water absorbing first layer over said substrate;
(c) applying a second layer over said first layer, said second layer being selected from the group consisting of:
(i) an anti-reflection coating, a mirror coating or a hard layer;
(ii) a composite or a combination of a hard layer and an anti-reflection coating; and
(iii) a composite or a combination of a hard layer and a mirror coating; and
(d) introducing spaced apart blind holes into the second layer and the water absorbing layer such that said blind holes extend completely through the second layer and penetrate at least partially through the water absorbing first layer.

12. A method, as claimed in claim 11, further comprising providing a hard layer between the glass substrate and the water absorbing layer, or between the water absorbing layer and the anti-reflection coating or mirror coating, or both between the glass substrate and the water absorbing layer and between the water absorbing layer and the anti-reflection coating or mirror coating.

13. A method, as claimed in claim 11, further comprising applying a hydrophobic or oleophobic coating over the second layer.

14. A method, as claimed in claim 11, wherein the blind holes are introduced by laser bombardment, sand blasting, electron beam lithography, ion beam processing, ultrasonic bombardment or a water jet.

15. A method, as claimed in claim 11, wherein the blind holes extend substantially perpendicular to the surface of the second layer.
